(19) United States
(12) Patent Application Publication
(10) Pub. No.: US 2025/0124565 A1
(43) Pub. Date: Apr. 17, 2025

(54) SEMICONDUCTOR PACKAGE MARK INSPECTION METHOD AND SEMICONDUCTOR DEVICE MANUFACTURING METHOD

(71) Applicant: Samsung Electronics Co., Ltd., Suwon-si (KR)

(72) Inventors: Minwoo Jeon, Suwon-si (KR); Kanggyune Lee, Suwon-si (KR)

(21) Appl. No.: 18/667,687

(22) Filed: May 17, 2024

(30) Foreign Application Priority Data
Oct. 17, 2023 (KR) 10-2023-0138928

(51) Int. Cl. G06T 7/00

(52) U.S. Cl. CPC G06T 7/001; G06T 2207/20084; G06T 2207/30148

(57) ABSTRACT

Provided is a mark inspection method of a semiconductor package. The method includes receiving a measured image of a semiconductor package comprising a mark including at least one of a figure and a character string, receiving a standard defect image corresponding to the measured image, the standard defect image includes the mark having a defect comprising at least one of misprinting, cutting, blur, noise, displacement, double printing, reverse printing, bay, and thermochromic phenomena, generating a fake image through a deep learning model using a generative adversarial network (GAN) with the measured image and the standard defect image, and comparing the fake image with the measured image.

### CROSS-REFERENCE TO RELATED APPLICATION

This application is based on and claims priority under 35 U.S.C. § 119 to Korean Patent Application No. 10-2023-0138928, filed on Oct. 17, 2023, in the Korean Intellectual Property Office, the disclosure of which is incorporated by reference herein in its entirety.

### BACKGROUND

Aspects of the inventive concept relate to a fake image generating method, a semiconductor package mark inspection method, and a semiconductor device manufacturing method, and more particularly, to a method of inspecting marks formed on semiconductor packages.

Machine vision technology is an important technology for automatic inspection of semiconductor packages. The automatic inspection of semiconductor packages may be classified into electrical characteristics and function inspection and exterior inspection, among which exterior inspection includes inspecting defects in a lead frame or a mark on the semiconductor package, etc.

In the exterior inspection, the position, direction, distortion, scratch, omission, and break of various marks indicating information on the semiconductor package such as a product name and a manufacturer name are inspected. As semiconductor packages are becoming increasingly smaller, it takes a lot of time and money to handle inspection items through visual inspection, and causes losses due to distribution of defective products due to misjudgment. Therefore, high-performance vision inspection technology has recently been developed and applied in the semiconductor mark inspection field.

### SUMMARY

Aspects of the inventive concept provide a fake image generating method for inspecting marks formed on semiconductor packages with high reliability, a semiconductor package mark inspection method, and a semiconductor device manufacturing method.

In addition, aspects of the inventive concept are not limited to those mentioned above, and other aspects of the inventive concept may be clearly understood by those skilled in the art from the description below.

According to an aspect of the inventive concept, there is provided a mark inspection method of a semiconductor package, the method including receiving a measured image of a semiconductor package comprising a mark including at least one of a figure and a character string, receiving a standard defect image corresponding to the measured image, the standard defect image includes the mark having a defect comprising at least one of misprinting, cutting, blur, noise, displacement, double printing, reverse printing, bay, and thermochromic phenomena, generating a fake image through a deep learning model using a generative adversarial network (GAN) with the measured image and the standard defect image, and comparing the fake image with the measured image.

According to another aspect of the inventive concept, there is provided a mark inspection method of a semiconductor package, the method comprising receiving a measured image of the semiconductor package comprising a mark, receiving a standard defect image corresponding to the measured image, the standard defect image includes the mark having a defect comprising at least one of misprinting, cutting, blur, noise, displacement, double printing, reverse printing, bay, and thermochromic phenomena, generating a fake image through a deep learning model using a GAN with the measured image and the standard defect image, and determining whether the measured image includes a defective mark based on the generated fake image.

According to another aspect of the inventive concept, there is provided a semiconductor device manufacturing method including preparing a wafer, performing a semiconductor process on the wafer, and performing a mark inspection process, wherein the performing of the mark inspection process includes receiving a measured image of a semiconductor device comprising a mark including at least one of a figure and a character string, receiving a standard defect image corresponding to the measured image, the standard defect image includes the mark having a defect comprising at least one of misprinting, cutting, blur, noise, displacement, double printing, reverse printing, bay, and thermochromic phenomena, generating a fake image through a deep learning model using a generative adversarial network (GAN) with the measured image and the standard defect image, and comparing the fake image with the measured image.

### BRIEF DESCRIPTION OF THE DRAWINGS

Embodiments will be more clearly understood from the following detailed description taken in conjunction with the accompanying drawings in which:

FIG. 1 is a flowchart of a semiconductor package mark inspection method according to an embodiment;

FIG. 2 is a diagram of a measured image of a semiconductor package including a mark according to an embodiment;

FIG. 3 is a flowchart of a fake image generating method according to an embodiment;

FIG. 4 is a diagram illustrating a method of setting a region of interest in a measured image, according to an embodiment;

FIG. 5 is a diagram of a standard defect image according to an embodiment;

FIG. 6 is a block diagram illustrating a method of generating a fake image by a fake image generating model according to an embodiment;

FIG. 7 is a conceptual diagram illustrating a process of generating a fake image through deep learning using a generative adversarial network (GAN) in the fake image generating model of FIG. 6;

FIG. 8 is a conceptual diagram illustrating a process of generating a fake image through deep learning using a self-attention algorithm in the fake image generating model of FIG. 6;

FIG. 9 is a flowchart of a semiconductor device manufacturing method including a mark inspection method according to an embodiment; and

FIG. 10 is a block diagram of a mark inspection device according to an embodiment.

### DETAILED DESCRIPTION OF THE EMBODIMENTS

Hereinafter, embodiments are described in detail with reference to the accompanying drawings. The same reference numerals are used for the same components in the drawings, and duplicate descriptions thereof are omitted.

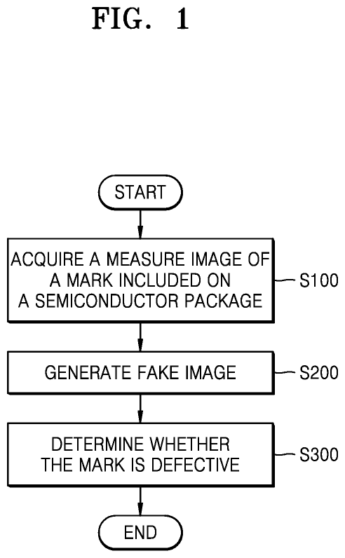

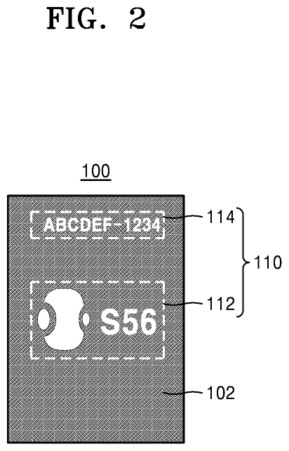

FIG. 1 is a flowchart of a semiconductor package mark inspection method according to an embodiment. FIG. 2 is a diagram of a measured image of a semiconductor package including a mark according to an embodiment. A semiconductor product to which the semiconductor package mark inspection method is applied may be a semiconductor chip package in which a semiconductor chip manufactured in a wafer state is separated into individual chips and assembled into a package after undergoing electrical characteristic inspection.

A mark 110 on the semiconductor package may be a unique identifier and/or a label formed in the exterior of the semiconductor package for tracking, identification, and/or quality control. For example, the mark 110 may include a logo of a semiconductor package manufacturing company or a logo of a manufacturing company of an electronic product including the semiconductor package. The mark 110 may be formed during a packaging process of a semiconductor device.

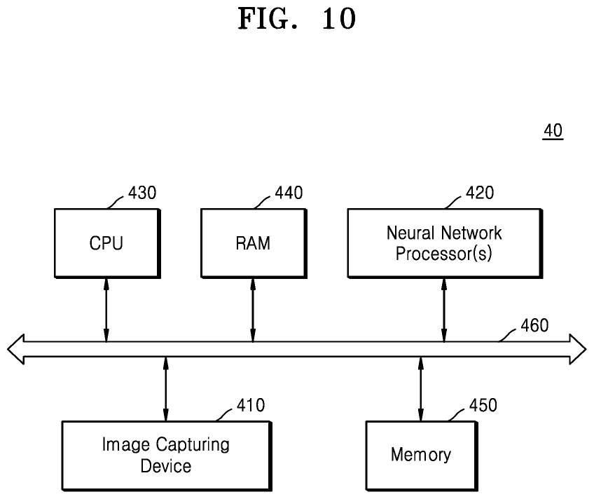

Referring to FIGS. 1 and 2, first, a measured image 100 (i.e., a “first image”) of the semiconductor package may be acquired (S100). The measured image 100 may include the mark 110. The mark inspection device (40 of FIG. 10) may capture an image of the semiconductor package using a camera. The captured image may represent the measured image 100.

The measured image 100 may include the mark 110 placed on a sealing layer 102 of the semiconductor package. The mark 110 may refer to an identifier and/or code displayed on the surface of the semiconductor package by printing and/or etching. For example, the mark 110 may include information of the semiconductor package.

For example, the mark 110 may include a product name mark 112 and a serial number mark 114. For example, the product name mark 112 may be placed adjacent to the center of the sealing layer 102, and the serial number mark 114 may be placed above the product name mark 112. However, the arrangement of the product name mark 112 and the serial number mark 114 is illustrative and may be modified in various ways. In addition, the mark 110 shown in FIG. 2 is only an embodiment of the mark 110 placed on the semiconductor package, and the mark 110 may include a more diverse series of character strings and/or figures depending on the semiconductor packaging product.

In FIG. 2, the measured image 100 is illustrated as having a pixel brightness of 0 to about 255, but the measured image 100 may be divided into a bright region and a dark region and divided into a foreground and a background.

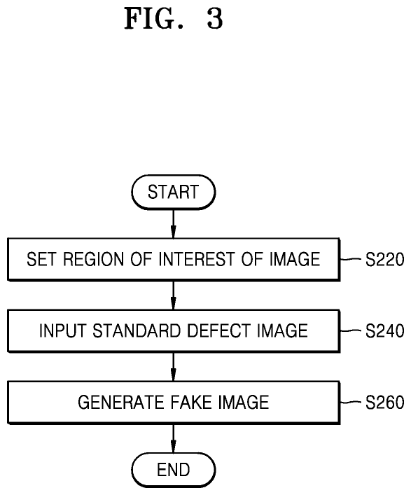

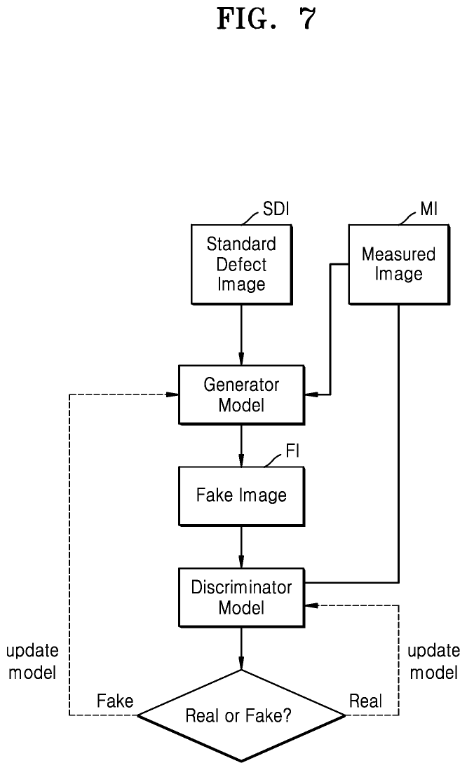

After operation S100 of acquiring the measured image 100, a fake image FI (i.e., a “second image”) may be generated (S200). The fake image (FI of FIG. 7) may be a standard for determining whether the measured image 100 includes a defective mark. The fake image (FI of FIG. 7) may be generated using a neural network. A method of generating the fake image (FI of FIG. 7) is described with reference to FIG. 3.

FIG. 3 is a flowchart of a fake image generating method according to an embodiment. Description is made with reference to FIG. 1 and FIG. 2 together.

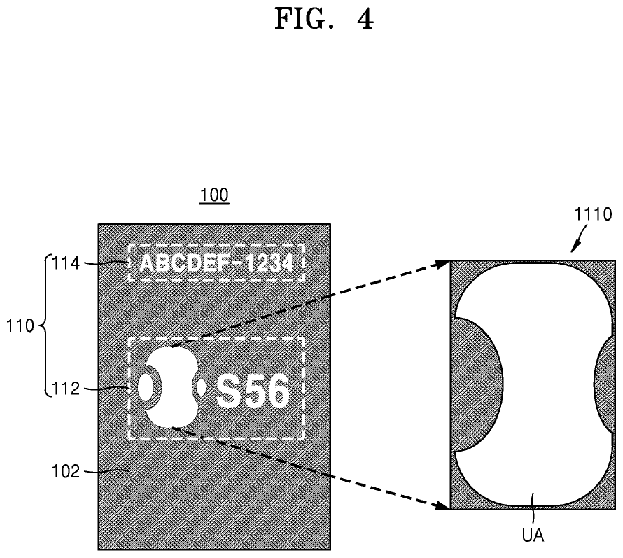

Referring to FIG. 3, first, a region of interest (ROI) of the measured image 100 may be set (S220). The ROI of the measured image 100 may refer to a region including the mark 110. That is, only the region including the mark 110 in the measured image 100 may be separated. A process of separating the ROI of the measured image 100 is described in more detail with reference to FIG. 4.

FIG. 4 is a diagram illustrating a method of setting an ROI in a measured image, according to an embodiment.

Referring to FIG. 4, the measured image 100 may include the sealing layer 102 and the mark 110. Although not shown in FIG. 4, in another embodiment, an operation of thresholding and converting the measured image 100 of FIG. 2 into a binary image may be further performed. The thresholding is an operation of converting pixels with a pixel brightness in the range of 0 to about 255 into a binary image with only values of 0 and 1. When the thresholding is performed, an object contained in the image may be separated from the background. In the thresholding process, for example, a value of a pixel brightness which is 180 or more may be processed as 1, and a value thereof which less than 180 may be processed as 0. However, the aforementioned 180, which is a reference for the pixel brightness, is just an arbitrary example, and the reference for the pixel brightness may vary depending on the embodiment.

The mark 110 may include the product name mark 112 and the serial number mark 114. A case in which the product name mark 112 includes a figure is described as an example herein. The product name mark 112 may include a figure and a character string. A case in which a semiconductor package mark inspection method is performed based on a FIG. 1110 of the product name mark 112 is described as an example herein.

To generate the fake image (FI of FIG. 7) for the FIG. 1110 of the product name mark 112, only the FIG. 1110 of the produce name mark 112 may be separated from the measured image 100. The FIG. 1110 of the product name mark 112 may be placed inside a unit UA. Later, the unit UA of the measured image 100 may be compared with a region corresponding to the unit UA in the fake image (FI of FIG. 7).

Returning to FIG. 3, after the ROI of the measured image 100 is set (S220), a standard defect image SDI (i.e., a “third image”) may be input (S240). The standard defect image SDI may refer to an image used to define and standardize a defective form or a defect of a semiconductor package product. The standard defect image SDI may include a mark 110 including a defect. For example, the standard defect image SDI may include the mark 110 including misprinting, cutting, blur, noise, tilt, double printing, reverse printing, bay (e.g., marking blocking), and/or thermochromic phenomena.

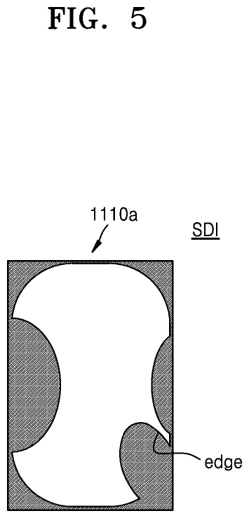

The standard defect image SDI may be an image stored in memory (450 of FIG. 10) of the mark inspection device (40 of FIG. 10). In another embodiment, the standard defect image SDI may be an image received from the outside of the mark inspection device (40 of FIG. 10). FIG. 5 shows the standard defect image SDI as an example.

FIG. 5 is a diagram of a standard defect image according to an embodiment. Description is made with reference to FIGS. 1 to 4 together.

Referring to FIG. 5, the standard defect image SDI may have a shape similar to the FIG. 1110 of the product name mark 112 of FIG. 4. Compared with the FIG. 1110 of the product name mark 112, the standard defect image SDI may have a defect in a portion of a FIG. 1110a. The standard defect image SDI of FIG. 5 may include a defect in at least a portion of an edge of the FIG. 1110a as an example. Compared to the FIG. 1110 of the product name mark 112 of FIG. 2, at least a portion of the edge of the FIG. 1110a of the standard defect image SDI may be missing. That is, the standard defect image SDI may include a mark including a misprinting phenomenon.

In FIG. 5, the standard defect image SDI is illustrated as having a pixel brightness of 0 to about 255, but the standard defect image SDI may be divided into a bright region and a dark region and divided into a foreground and a background.

According to an embodiment, the measured image 100 and the standard defect image SDI may have the same type of background. In another embodiment, the measured image 100 and the standard defect image SDI may include different types of background (e.g., binary image and gray scale level image).

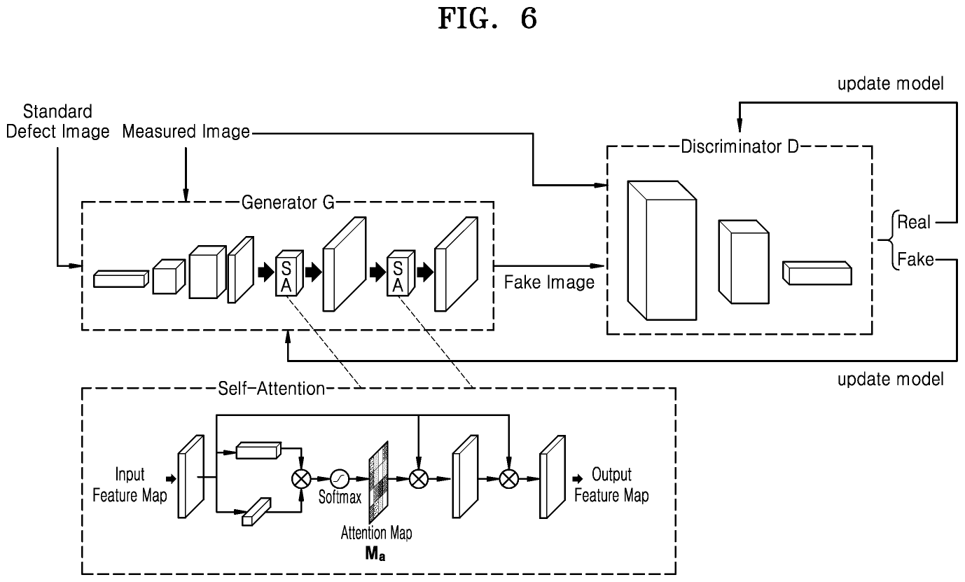

Returning to FIG. 3, after the mark inspection device (40 in FIG. 10) receives the standard defect image SDI (S240), a fake image may be generated (S260). The measured image MI and the standard defect image SDI may be input to a fake image generating model. The fake image generating model may generate the fake image FI based on the measured image MI and the standard defect image SDI. The fake image generating model may generate the fake image FI by a machine learning method (e.g., a deep learning method). A method of generating the fake image FI by the fake image generating model is described in detail with reference to FIGS. 6 to 8.

FIG. 6 is a block diagram illustrating a method of generating a fake image by a fake image generating model according to an embodiment. Description is made with reference to FIGS. 1 to 5 together.

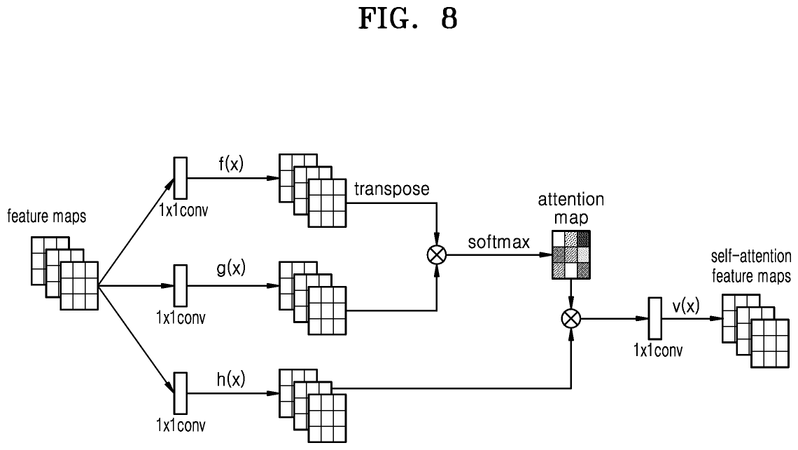

Referring to FIG. 6, the fake image generating model may include a generative adversarial network (GAN) and a self-attention algorithm. In FIG. 6, the self-attention algorithm placed inside a generator model G is represented by SA. The measured image MI and the standard defect image SDI may be input to the generator model G. The generator model G generates the fake image based on the measured image and the standard defect image SDI. In the process of generating the fake image FI by the generator model G, a self-attention algorithm may be used. The generated fake image FI and the measured image MI are input to a discriminator model D, and whether the two images are the same/similar may be determined. As the generator model G generates the fake image FI based on the standard defect image SDI, the generator model G may be trained in a semi-supervised manner. Therefore, the fake image generating method and the mark inspection method may be learned in a semi-supervised manner. The process of generating the fake image FI by the generator model G, and determining whether the fake image FI and the measured image MI are the same/similar using the discriminator model D is described in more detail with reference to FIG. 7. In addition, the self-attention algorithm is described in more detail with reference to FIG. 8.

FIG. 7 is a conceptual diagram illustrating a process of generating a fake image through deep learning using a GAN in the fake image generating model of FIG. 6. Description is made with reference to FIGS. 1 to 6 together.

Referring to FIG. 7, the fake image generating model may use the measured image MI and the standard defect image SDI as a learning image of the GAN. To briefly explain GAN, the GAN is a deep learning-based generative algorithm and may include two sub-models. That is, the GAN may include the generator model G and the discriminator model D. The generator model G may correspond to the fake image generating model in the semiconductor package mark inspection model herein. The generator model G generates new fake images FI, and the discriminator model D determines whether the generated fake images TI are actual data or fake data generated by the generator model G.

For example, in relation to the semiconductor package mark inspection method herein, the generator model G may convert the standard defect image SDI into fake images FI. As described above, the input image may include the measured image MI and the standard defect image SDI. In addition, the discriminator model D may receive an output image (e.g., fake image FI) from the generator model G and a reference image (e.g., measured image MI). The discriminator model D compares the output image with the reference image and determines whether the output image is a real image or a fake image generated by the generator model G. That is, the discriminator model D may compare the output image with the reference image to determine whether the output image is real. In other words, when the output image and the reference image are substantially the same, the discriminator model D may determine that the output image is real (e.g., a measured image and not an image generated by the generator model G), and when there is a difference between the output image and the reference image, the discriminator model D may determine that the output image is fake.

Specifically, in FIG. 7, when the standard defect image SDI and the measured image MI are input to the generator model G, the generator model G generates an output image. In addition, the output image and the reference image are input to the discriminator model D. The discriminator model D determines whether the output image is the same as the reference image. Thereafter, according to the determination result, the generator model G and the discriminator model D are continuously updated. By updating the models, the discriminator model D may produce a more plausible image, and the generator model G may classify a real image and a fake image more precisely When the output image and the reference image are the same, the discriminator model D may be updated, and when the output image and the reference image are different, the generator model G may be updated. When the discriminator model D reaches a level at which the output image and the reference image are no longer distinguished as this process is continuously repeated, the learning ends, and the generator model G at this time may be adopted as a final prediction model. The discriminator model D may be discarded when the learning ends.

FIG. 8 is a conceptual diagram illustrating a process of generating a fake image through deep learning using a self-attention algorithm in the fake image generating model of FIG. 6. Description is made with reference to FIGS. 1 to 7 together.

Referring to FIG. 8, the generator model G of FIG. 6 may include a self-attention algorithm. The self-attention algorithm may provide a method of calculating the association of each element (e.g., sequence) in input data with other elements. For example, when the self-attention algorithm for an image is included in the generator model G, the relationship and association between each portion of the image (e.g., a plurality of regions of the image) may be calculated. More specifically, the generator model G may divide the input image into a plurality of regions and convert each region into a vector. Based on the vectors, the self-attention algorithm may model the relationship between each vector. Therefore, the generator model G may include the self-attention algorithm, and the generator model G may learn the overall characteristic of the input image to generate the output image. That is, the fake image generating model may include a self-attention generative adversarial network (SAGAN) including self-attention layers.

That is, the generator model G of the SAGAN may be different from a generator model of a general GAN in that the generator model G of the SAGAN includes the self-attention mechanism. In addition, the discriminator model D of the SAGAN may be substantially the same as a discriminator model of a general GAN.

Feature maps may be input to the self-attention algorithm of FIG. 8. After converting the dimensions of the input feature maps, each of the dimensionally converted feature maps may be converted into three feature spaces. FIG. 8 shows a process of converting the dimensionally transformed feature maps into feature spaces of f(x), g(x), and h(x). Thereafter, an attention map Ma may be calculated by applying a softmax function to at least two of the feature spaces (e.g., f(x) and g(x)) from conversion. Through the product of the attention map and the feature space (e.g., h(x)), the self-attention feature map may be calculated. The calculated self-attention feature map may correspond to the output feature map of FIG. 6. As may be seen from FIG. 6, the input feature map and the output feature map may have the same dimension.

Returning to FIG. 1, it is determined whether the measured image MI is defective (S300). The mark inspection device (40 of FIG. 10) may compare the measured image MI with the generated fake image FI to determine whether the mark 110 on the measured image MI is defective. The mark inspection device (40 of FIG. 10) may calculate the similarity between the mark on the measured image MI and the mark on the generated fake image FI. For example, the mark inspection device (40 of FIG. 10) may compare the pixel value of the mark 110 on the measured image MI with the pixel value of the mark on the fake image FI to determine whether the mark 110 on the measured image MI is defective. For example, the mark inspection device (40 of FIG. 10) may compare the pixel size of the mark 110 on the measured image MI with the pixel size of the mark on the fake image FI to determine whether the mark on the measured image MI is defective. For example, the mark inspection device (40 of FIG. 10) may determine whether the mark 110 on the measured image MI is defective by comparing the shape of the mark 100 on the measured image MI to the shape of the mark on the fake image FI.

For example, when the matching ratio between the mark 110 on the measured image MI and the mark on the fake image FI is less than a preset threshold, the mark inspection device (40 of FIG. 10) may determine that the mark 110 on the measured image MI is normal. Conversely, when the matching ratio between the mark 110 on the measured image MI and the mark on the fake image FI is higher than a preset threshold, the mark inspection device (40 of FIG. 10) may determine that the mark 100 on the measured image MI is defective.

A general fake image generating model includes a general GAN model. The generator model of the general GAN uses a convolution network generate images. However, convolutional networks have a long-term dependency problem in which the influence of data separated by a large distance is reduced.

On the other hand, the fake image generating model may include a SAGAN model. Unlike the general GAN model, the SAGAN model may further include a self-attention algorithm in the generator model G. The self-attention algorithm may calculate the association between data through the attention algorithm. Thus, the self-attention algorithm may reduce the distance dependency on the data. Therefore, the long-term dependency problem of the generator model G is reduced, and the fake image generating model may generate a highly reliable fake image FI.

The semiconductor package mark inspection method has been described with reference to FIGS. 1 to 8, but is not limited thereto. For example, the described mark inspection method may be applied to various products including the mark 110.

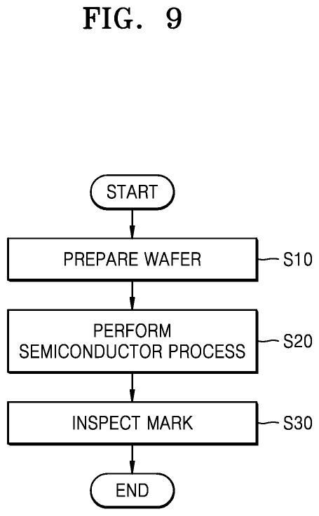

FIG. 9 is a flowchart of a semiconductor device manufacturing method including a mark inspection method according to an embodiment. Description is made with reference to FIGS. 1 to 8 together.

Referring to FIG. 9, a wafer may be prepared first (S10). The wafer may include, for example, a bare wafer on which one or more semiconductor processes have been performed or on which a semiconductor process has not been performed.

Thereafter, a semiconductor process may be performed on the wafer (S20). For example, an oxidation process, a photo process, an etching process, an ion process, a deposition process, and/or a cleaning process may be performed on the wafer. In addition, a singularization process of individualizing the wafer into semiconductor chips, a test process of testing the semiconductor chips, and/or a packaging process of packaging the semiconductor chips may be included.

Thereafter, a mark inspection process may be performed (S30). The mark inspection process may inspect a mark placed on the semiconductor package. The operation of performing the mark inspection process (S30) may include generating a fake image and comparing the generated fake image with a measured image. That is, operation S30 may include operation S100 of acquiring the image of FIG. 1, operation S200 of generating the fake image, and operation S300 of determining whether the image is defective. A semiconductor device may be completed through the mark inspection process. Additionally, in another embodiment, a semiconductor process may be further performed after the mark inspection process.

FIG. 10 is a block diagram of a mark inspection device according to an embodiment. Description is made with reference to FIGS. 1 to 9 together.

Referring to FIG. 10, the mark inspection device 40 may generate the fake image using the neural network, compare the generated fake image to the inspected image, and determine whether the mark on the semiconductor package is normal. The mark inspection device 40 may include an image capturing device 410, a neural network processor 420, a central processing unit (CPU) 430, random access memory (RAM) 440, memory 450, and a bus 460.

According to an embodiment, the mark inspection device 40 may further include other general-purpose components in addition to the components illustrated in FIG. 10. For example, the mark inspection device 40 may further include an input/output module, a security module, and a power control device, and may also include various types of processors. In addition, depending on an embodiment, at least one of the components in FIG. 10 may be omitted from the mark inspection device 40. The components of the mark inspection device 40 may communicate with each other through the bus 460.

The image capturing device 410 may be configured to photograph the semiconductor package and photograph the mark 110 provided on (e.g., engraved on) the sealing layer 102 of the semiconductor package. The image capturing device 410 may photograph the semiconductor package on which a packaging process has been performed. For example, the image capturing device 410 may include a camera.

The neural network processor 420 may infer information included in the input data by training (or learning) the neural network or analyzing input data using the neural network. The neural network processor 420 may determine a situation based on the inferred information or control configurations of the mounted electronic device.

In addition, the neural network processor 420 may receive input data from the image capturing device 410 and the memory 450 and may generate output data based on the received input data. The neural network processor 420 may extract the ROI from the measured image MI, generate the fake image FI based on the measured image MI and the standard defect image SDI, and compare the fake image with the measured image MI to inspect the mark on the semiconductor package.

Additionally, in another embodiment, the mark inspection device 40 further includes a processor, and the processor may perform an operation of extracting the ROI from the measured image MI and/or an operation of comparing the fake image FI with the measured image MI

The neural network processor 420 may be implemented as a neural network operation accelerator, a coprocessor, a digital signal processor (DSP), an application specific integrated circuit (ASIC), a field-programmable gate array (FPGA), a graphics processing unit (GPU), a neural processing unit (NPU), a tensor processing unit (TPU), and a multi-processor system-on-chip (MPSoC).

The neural network processor 420 may be a neural network model based on an artificial neural network (ANN), a convolution neural network (CNN), a region with convolution neural network (R-CNN), a region proposal network (RPN), a recurrent neural network (RNN), a GAN, a SAGAN, a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, a plain residual network, a dense network, a hierarchical pyramid network, a transformer, and/or a vision transformer network. The type of the neural network model is not limited to the above-described example.

The CPU 430 may control the overall operation of the mark inspection device 40. The CPU 430 may include a single-core CPU or a multi-core CPU. The CPU 430 may process or execute programs and/or data stored in a storage area such as the memory 450 by using the RAM 440.

For example, the CPU 430 may execute an application program and control the neural network processor 420 to perform required neural network-based tasks according to the execution of the application program.

The memory 450 may store the standard defect image SDI. The standard defect image SDI may include the mark 110 including a defect. For example, the standard defect image SDI may include the mark 110 including misprinting, cutting, blur, noise, tilt, double printing, reverse printing, bay, and/or thermochromic phenomena.

The memory 450 may include at least one of volatile memory or nonvolatile memory. The non-volatile memory includes read only memory (ROM), programmable ROM (PROM), electrically programmable ROM (EPROM), electrically erasable and programmable ROM (EEPROM), flash memory, etc. The volatile memory includes dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM). In an embodiment, the memory 450 may include at least one of a hard disk drive (HDD), a solid state drive (SSD), a compact flash (CF) card, a secure digital (SD) card, a micro secure digital (Micro-SD) card, a mini secure digital (Mini-SD) card, an extreme digital (xD) card, or a memory stick.

While aspects of the inventive concept have been particularly shown and described with reference to embodiments thereof, it will be understood that various changes in form and details may be made therein without departing from the spirit and scope of the following claims.

What is claimed is:

1. A mark inspection method of a semiconductor package, the method comprising:
receiving a measured image of a semiconductor package comprising a mark including at least one of a figure and a character string;
receiving a standard defect image corresponding to the measured image, the standard defect image includes the mark having a defect comprising at least one of misprinting, cutting, blur, noise, displacement, double printing, reverse printing, bay, and thermochromic phenomena;
generating a fake image through a deep learning model using a generative adversarial network (GAN) with the measured image and the standard defect image; and
comparing the fake image with the measured image.

2. The mark inspection method of claim 1, wherein the generating of the fake image comprises:
setting a region of interest for the measured image; and
inputting the standard defect image corresponding to the region of interest.

3. The mark inspection method of claim 1, wherein each of the measured image and the standard defect image has a pixel brightness of 0 to about 255.

4. The mark inspection method of claim 1, wherein the GAN comprises a generator model and a discriminator model, and
the generator model generates the fake image based on the measured image and the standard defect image.

5. The mark inspection method of claim 1, further comprising setting a region of interest for the measured image,
wherein the region of interest comprises the mark.

6. The mark inspection method of claim 1, wherein the GAN is learned in a semi-supervised manner.

7. The mark inspection method of claim 1, wherein the mark includes an identification mark engraved on a sealing layer of the semiconductor package.

8. A mark inspection method of a semiconductor package, the method comprising:
receiving a measured image of the semiconductor package comprising a mark;
receiving a standard defect image corresponding to the measured image, the standard defect image includes the mark having a defect comprising at least one of misprinting, cutting, blur, noise, displacement, double printing, reverse printing, bay, and thermochromic phenomena;
generating a fake image through a deep learning model using a generative adversarial network (GAN) with the measured image and the standard defect image; and
determining whether the measured image includes a defective mark based on the generated fake image.

9. The mark inspection method of claim 8, wherein the GAN comprises a self-attention algorithm.

10. The mark inspection method of claim 8, wherein the GAN comprises a generator model and a discriminator model, and
the measured image is input to each of the generator model and the discriminator model.

11. The mark inspection method of claim 10, wherein the generator model generates the fake image based on the measured image and the standard defect image, and
the discriminator model compares the measured image with the fake image to determine whether the generated fake image is the same as the measured image.

12. The mark inspection method of claim 11, wherein, when the generated fake image is determined to be different from the measured image, the generator model is updated, and
when the generated fake image is determined to be the same as the measured image, the discriminator model is updated.

13. The mark inspection method of claim 8, wherein the determining of whether the measured image includes a defective mark is performed by comparing the mark on the measured image with a mark on the fake image.

14. The mark inspection method of claim 13, wherein the comparing of the mark on the measured image with the mark on the fake image comprises:
calculating a matching ratio between the mark on the measured image and the mark on the fake image,
when the matching ratio is less than a set reference value, determining that the mark included in the measured image is not defective, and
when the matching ratio is greater than the set reference value, determining that the mark included in the measured image is defective.

15. The mark inspection method of claim 8, wherein the generating of the fake image comprises:
setting a region of interest for the measured image; and
inputting the standard defect image corresponding to the region of interest.

16. The mark inspection method of claim 8, wherein each of the measured image and the standard defect image has a pixel brightness of 0 to about 255.

17. A semiconductor device manufacturing method comprising:
preparing a wafer;
performing a semiconductor process on the wafer; and
performing a mark inspection process,
wherein the performing of the mark inspection process includes
receiving a measured image of a semiconductor device comprising a mark including at least one of a figure and a character string,
receiving a standard defect image corresponding to the measured image, the standard defect image includes the mark having a defect comprising at least one of misprinting, cutting, blur, noise, displacement, double printing, reverse printing, bay, and thermochromic phenomena,
generating a fake image through a deep learning model using a generative adversarial network (GAN) with the measured image and the standard defect image, and
comparing the fake image with the measured image.

18. The semiconductor device manufacturing method of claim 17, wherein the generating of the fake image includes
setting a region of interest for the measured image, and
inputting the standard defect image corresponding to the region of interest.

19. The semiconductor device manufacturing method of claim 17, wherein the GAN comprises a self-attention generative adversarial network (SAGAN).

20. The semiconductor device manufacturing method of claim 17, further comprising determining whether the measured image includes a defective mark based on the generated fake image,
wherein the determining of whether the measured image includes a defective is performed by comparing the mark included in the measured image with a mark included in the fake image.
